(19) United States
(12) Patent Application Publication
(10) Pub. No.: US 2025/0363342 A1
(43) Pub. Date: Nov. 27, 2025

(54) METHOD AND APPARATUS FOR ANALYZING BRAIN-INSPIRED NEURAL NETWORK BASED ON NETWORK REPRESENTATION LEARNING

(71) Applicant: Electronics and Telecommunications Research Institute, Daejeon (KR)

(72) Inventor: Youngmok HA, Seoul (KR)

(73) Assignee: Electronics and Telecommunications Research Institute, Daejeon (KR)

(21) Appl. No.: 19/207,754

(22) Filed: May 14, 2025

(30) Foreign Application Priority Data
May 22, 2024 (KR) 10-2024-0066410
May 12, 2025 (KR) 10-2025-0061191

(51) Int. Cl. G06N 3/06; G06N 3/096

(52) U.S. Cl. CPC G06N 3/061; G06N 3/096

(57) ABSTRACT

Disclosed herein are a method and apparatus for analyzing a brain-inspired neural network, the method being performed by an apparatus for analyzing the brain-inspired neural network, the method including converting an input brain-inspired neural network into a computational graph, performing attention computation on the computational graph based on a graph attention network, and outputting a result of network representation learning for the brain-inspired neural network based on the attention computation.

### CROSS REFERENCE TO RELATED APPLICATIONS

This application claims the benefit of Korean Patent Application Nos. 10-2024-0066410, filed May 22, 2024 and 10-2025-0061191, filed May 12, 2025, which are hereby incorporated by reference in their entireties into this application.

### BACKGROUND OF THE INVENTION

### 1. Technical Field

The present disclosure relates generally to technology for analyzing brain-inspired neural networks, and more particularly to technology for analyzing a computational graph for brain-inspired neural networks based on network representation learning.

### 2. Description of the Related Art

The analysis of brain-inspired neural networks (BNNs) has long been a subject of interest due to the influence thereof across various fields such as neuroscience and artificial intelligence (AI). BNNs facilitate the reconstruction of brain structures and the simulation of brain functions, thereby enhancing understanding of how the biological brain processes information, how neural pathways are interconnected, and how these interconnections affect behavior and cognitive functions. Additionally, as seen in artificial neural networks such as multilayer perceptrons, convolutional neural networks, and liquid state machines, BNNs promote the development of AI systems capable of surpassing human performance in cognitive tasks. Further, BNNs inspire a new paradigm of brain-inspired computing different from conventional computing based on the von Neumann architecture. Furthermore, BNNs are supported by optimization algorithms to enable resource-efficient execution on dedicated hardware and to ensure optimal performance in actual applications such as pattern recognition and decision-making.

Currently, in the field of BNN analysis, network representation learning (NRL) for BNNs has been neither sufficiently studied nor developed. NRL is a learning paradigm that learns the latent representations of a network and projects network components (e.g., nodes and edges) into a vector space while preserving the topological structure, functionality, and other relevant auxiliary information of the network. NRL having capability of expressing networks as numerical vectors allows for the application of vector-based analytical methodologies. Therefore, although NRL is widely used in network understanding and optimization and there have been attempts to handle representations of spiking neural networks (SNNs) corresponding to a subclass of BNNs, these approaches do not focus on representations themselves or on representation learning. Instead, those approaches explore representational similarities between SNNs and ANNs through central kernel alignment.

Meanwhile, other studies have proposed NRL to analyze structural or functional connectivity between brain regions, but such study focuses more on functional Magnetic Resonance Imaging (fMRI) scan data of the biological brain rather than on BNNs that are computational models.

Therefore, there is a need for a new NRL framework for the analysis of BNNs.

### PRIOR ART DOCUMENTS

### Patent Document

(Patent Document 1) Chinese Patent Application Publication No. 115146668, Date of Publication: Oct. 4, 2022 (Title: Brain Network Representation Learning Method of Self-Attention Dynamic Graph Neural Network)

### SUMMARY OF THE INVENTION

Accordingly, the present disclosure has been made keeping in mind the above problems occurring in the prior art, and an object of the present disclosure is to present a new network representation learning (NRL) framework for the analysis of a brain-inspired neural network (BNN).

Another object of the present disclosure is to convert a BNN into a computational graph and to learn and derive representations of the BNN by utilizing a graph attention network (GAT) that receives the converted computational graph as input.

In accordance with an aspect of the present disclosure to accomplish the above objects, there is provided a method for analyzing a brain-inspired neural network, the method being performed by an apparatus for analyzing the brain-inspired neural network, the method including converting an input brain-inspired neural network into a computational graph; performing attention computation on the computational graph based on a graph attention network; and outputting a result of network representation learning for the brain-inspired neural network based on the attention computation.

The computational graph may include computational nodes corresponding to a neuron node, a soma node, a dendrite node, an axon node, and a synapse node.

The computational nodes may correspond to a string type.

The soma node, the dendrite node, and the axon node may belong to any one neuron node.

The neuron node may include features corresponding to a firing pattern, firing frequency, a list of firing times, an associated region, a type of associated neural network, a neuron type, a list vector of computational nodes constituting the neuron node, and a list vector of unique identification numbers for respective computational nodes constituting the neuron node.

The soma node, the dendrite node, and the axon node may include features corresponding to the identification numbers for respective node types of an associated neuron node.

The soma node may include features corresponding to a firing pattern, firing frequency, and a list vector of firing times.

The synapse node may include features corresponding to a list vector of difference values between firing times of presynaptic and postsynaptic neurons when an input computational node and an output computational node are configured to correspond to the neuron node, the soma node, the dendrite node, and the axon node, an average value of the difference values when the input computational node and the output computational node are configured to correspond to the neuron node, the soma node, the dendrite node, and the axon node, transmission efficacy/weight of neurotransmitters in a synapse, and a type of the synapse.

The graph attention network may perform the attention computation by combining hierarchical attention with masked self-attention.

The hierarchical attention may be performed by applying a hierarchical structure of the neuron node.

The masked self-attention may reflect an information flow between time-dependent computational nodes based on a sequential progression starting from the neuron node and corresponding to the dendrite node, the soma node, the axon node, and the synapse node.

The masked self-attention may be applied in units of a computational node corresponding to each element in an N×N matrix indicating vectors corresponding to the computational nodes.

The result of the network representation learning may correspond to an N×N matrix indicating vectors corresponding to the computational nodes, and each element in the N×N matrix may be implemented with an M×M matrix indicating feature vectors for a corresponding computational node.

The feature vectors for the corresponding computational node may be separated based on a separator (SEP) token.

The hierarchical attention may reflect information of lower-level computational nodes in a higher-level computation node based on a classification (CLS) token.

In accordance with another aspect of the present disclosure to accomplish the above objects, there is provided an apparatus for analyzing a brain-inspired neural network, including a computational graph conversion module configured to convert an input brain-inspired neural network into a computational graph; a network representation learning module configured to perform attention computation on the computational graph based on a graph attention network, and output a result of network representation learning for the brain-inspired neural network based on the attention computation; and memory.

The computational graph may include computational nodes corresponding to a neuron node, a soma node, a dendrite node, an axon node, and a synapse node.

The computational nodes may correspond to a string type.

The soma node, the dendrite node, and the axon node may belong to any one neuron node.

The neuron node may include features corresponding to a firing pattern, firing frequency, a list of firing times, an associated region, a type of associated neural network, a neuron type, a list vector of computational nodes constituting the neuron node, and a list vector of unique identification numbers for respective computational nodes constituting the neuron node.

The soma node, the dendrite node, and the axon node may include features corresponding to the identification numbers for respective node types of an associated neuron node.

The soma node may include features corresponding to a firing pattern, firing frequency, and a list vector of firing times.

The synapse node may include features corresponding to a list vector of difference values between firing times of presynaptic and postsynaptic neurons when an input computational node and an output computational node are configured to correspond to the neuron node, the soma node, the dendrite node, and the axon node, an average value of the difference values when the input computational node and the output computational node are configured to correspond to the neuron node, the soma node, the dendrite node, and the axon node, transmission efficacy/weight of neurotransmitters in a synapse, and a type of the synapse.

The graph attention network may perform the attention computation by combining hierarchical attention with masked self-attention.

The hierarchical attention may be performed by applying a hierarchical structure of the neuron node.

The masked self-attention may reflect an information flow between time-dependent computational nodes based on a sequential progression starting from the neuron node and corresponding to the dendrite node, the soma node, the axon node, and the synapse node.

The masked self-attention may be applied in units of a computational node corresponding to each element in an N×N matrix indicating vectors corresponding to the computational nodes.

The result of the network representation learning may correspond to an N×N matrix indicating vectors corresponding to the computational nodes, and each element in the N×N matrix may be implemented with an M×M matrix indicating feature vectors for a corresponding computational node.

The feature vectors for the corresponding computational node may be separated based on a separator (SEP) token.

The hierarchical attention may reflect information of lower-level computational nodes in a higher-level computation node based on a classification (CLS) token.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a diagram illustrating an example of computational graph representation;

FIG. 2 is a diagram illustrating an example of analysis of a computation graph;

FIG. 3 is a diagram illustrating an example of self-attention;

FIG. 4 is a diagram illustrating an example of masked attention;

FIG. 5 is a diagram illustrating an example of hierarchical attention;

FIG. 6 is a diagram illustrating an example of a BNN neuron structure;

FIG. 7 is a diagram illustrating an example of a BNN synapse structure;

FIG. 8 is a diagram illustrating an example in which a BNN neuron is represented in a three-dimensional (3D) geometric space;

FIG. 9 is an operation flowchart illustrating a method for analyzing a brain-inspired neural network based on network representation learning according to an embodiment of the present disclosure;

FIG. 10 is a diagram illustrating an example of a network representation learning framework according to the present disclosure;

FIG. 11 is a diagram illustrating an example of a process of obtaining a set matrix (X) of feature vectors of computational nodes from the feature vectors through embedding and normalization according to the present disclosure;

FIG. 12 is a diagram illustrating an example of a basic NRL framework according to the present disclosure;

FIG. 13 is a diagram illustrating an example of an NRL block illustrated in FIG. 12;

FIG. 14 is a diagram illustrating an example of bidirectional masked self-attention according to the present disclosure;

FIG. 15 is a diagram illustrating a correlation between computational nodes according to an embodiment of the present disclosure;

FIGS. 16 to 18 are diagrams illustrating an example of a masking method in which the flow of serial information between time-dependent computational nodes is taken into consideration according to the present disclosure;

FIGS. 19 and 20 are diagrams illustrating an example of a masking method in which the flow of parallel information between time-dependent computational nodes is taken into consideration according to the present disclosure;

FIGS. 21 and 22 are diagrams illustrating examples of a feature vector matrix X separated into SEP tokens and results obtained when the feature vector matrix X passes through a score function according to the present disclosure;

FIG. 23 is a diagram illustrating an example of a hierarchical relationship between computational nodes according to the present disclosure;

FIG. 24 is a diagram illustrating an example of a new feature vector used by a hierarchical NRL framework according to the present disclosure;

FIG. 25 is a diagram illustrating an example of a hierarchical NRL framework according to the present disclosure;

FIG. 26 is a diagram illustrating an example of the hierarchical NRL block illustrated in FIG. 25; and

FIG. 27 is a diagram illustrating an apparatus for analyzing a brain-inspired neural network based on network representation learning according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to make the gist of the present disclosure unnecessarily obscure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated to make the description clearer.

In the present specification, each of phrases such as “A or B”, “at least one of A and B”, “at least one of A or B”, “A, B, or C”, “at least one of A, B, and C”, and “at least one of A, B, or C” may include any one of the items enumerated together in the corresponding phrase, among the phrases, or all possible combinations thereof.

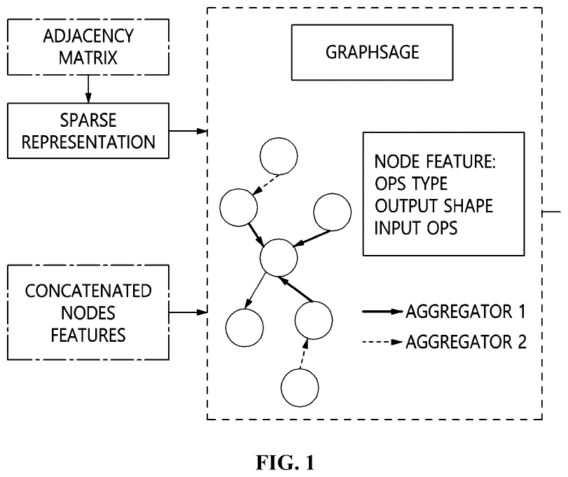

FIG. 1 is a diagram illustrating an example of computational graph representation.

Referring to FIG. 1, computational graph representation is generally used to describe a computational model in a deep learning framework such as TensorFlow, MXNet, Caffe, or Pytorch. In a computational graph, representation of nodes and edges is occasionally related to computation and data flows.

In an example, in the computational graph of TensorFlow, when execution of computation such as Add, Matrix Multiplication (MatMul), Rectified Linear Unit (ReLU), or Concatenate (Concat) is represented, each node may have multiple inputs and outputs (I/O). Here, a regular edge represents a data flow between operations (computations). Further, a special edge represents control dependency, which means that a destination node may begin execution only after a source node has completed execution.

In another example, nodes related to computations in the computational graph may be designed to encompass various features. These features may include the type of computation, the type of I/O computation, the format of computation I/O data, distance (or number of hops) between computations, memory usage of each computation, the type of machine on which computation is executed, execution time of computation, and the validity of computation scheduling.

Here, the technology illustrated in FIG. 1 shows a process of analyzing and projecting the computational graph of a machine learning model into a low-dimensional space using GraphSAGE. Here, GraphSAGE is a graph neural network model specifically designed for learning node representations in large graphs. For example, GraphSAGE may operate inductively to capture both local and global structures, and may then be generalized to nodes not seen during training. Further, GraphSAGE may function through two main stages, that is, sampling and aggregation. First, in the sampling stage, a fixed number of neighboring nodes for each target node in the graph may be selected. Then, in the aggregation stage, information from sampled neighboring nodes may be aggregated and summarized to learn the corresponding node's representation.

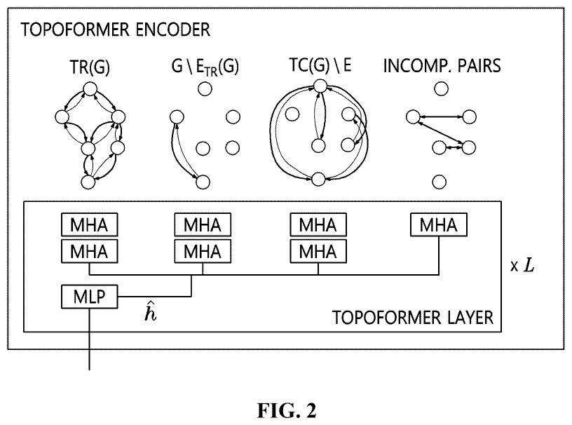

FIG. 2 is a diagram illustrating an example of analysis of a computational graph.

Referring to FIG. 2, the analysis of a computational graph may be fundamentally performed based on graph analysis methodology because the computational graph belongs to one category of graphs. For example, examples of the graph analysis methodology may include Graph Convolutional Network, GraphSAGE, Transformer, Graph Attention Network, GFlowNet, or the like.

For example, technology illustrated in FIG. 2 shows masked multi-head self-attention, wherein structural information is received as input in seven versions of computational graph conversion, each version including various topological features of operand nodes and edges. In order to understand the relationship and information flow between nodes in each computational graph, each layer of an encoder may utilize seven multi-head self-attention mechanisms. Further, in order to update and capture the feature of each operand node, a feed-forward neural network is used.

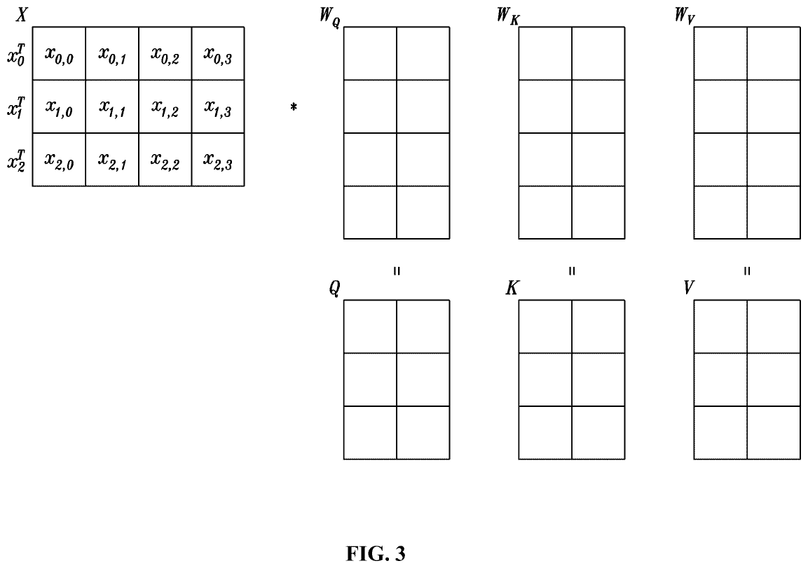

Hereinafter, various attention types are described with reference to FIGS. 3 to 5.

First, FIG. 3 is a diagram illustrating an example of self-attention.

Referring to FIG. 3, Self-Attention (SA) corresponds to a technique for searching for a correlation between components constituting a vector and re-representing the vector based on the correlation.

For example, assuming that, for non-negative integers m and n, there are a certain vector having a length of n, that is, xᵢ=[xᵢ₀, xᵢ₁, . . . , xᵢ₍ₙ₋₁₎]^{T} (where 0≤i<m) and a set matrix of the vector X=[x₀, x₁, . . . , xₘ₋₁]^{T}, self-attention calculates three set matrices of different vectors from X, that is, Q=X*W_{Q}, K=X*W_{K}, and V=X*W_{V}. Here, * denotes a matrix multiplication, matrices W_{Q}, W_{K}, and W_{V} are parameters generally learned through gradient descent and correspond to the same form (e.g., n×d for a positive integer d).

Here, the self-attention may perform calculation of a score function that receives Q and K as input after obtaining Q, K, and V. There are various types of score functions, and representative examples thereof may include dot, scaled dot, general, concatenation (concat), and location-based scores.

Here, the score calculated by self-attention may be represented by a matrix having the form of m×m. For example, the score may be represented by Q*KT. Such a matrix may refer to a correlation between vectors constituting X that has different meanings depending on the meanings of W_{Q}, Wₖ, and the score function. That is, self-attention may perform softmax on each of rows constituting such a correlation matrix, multiply the result of performing softmax by V through matrix multiplication, and represent the result of the matrix multiplication by an m×d matrix.

Here, the m×d matrix derived by the self-attention is obtained by re-representing m vectors constituting X in a d-dimensional space, and the specific meaning thereof varies depending on the direction in which W_{Q}, W_{K}, and W_{V} are learned and the score function used.

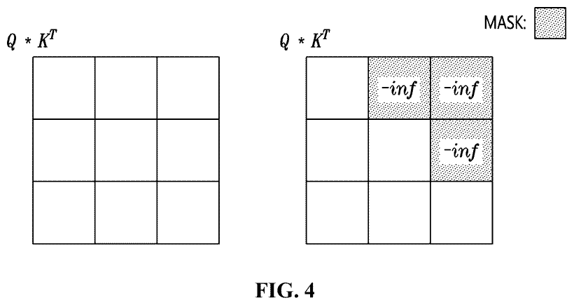

Also, FIG. 4 is a diagram illustrating an example of masked attention.

Referring to FIG. 4, the Masked Attention (MA) may be used when specific vectors constituting X do not clearly have correlations in any direction, or when a self-attention user intentionally desires to exclude correlations between specific vectors.

For example, the masked self-attention may additionally perform a process of overlaying −inf values, as shown in FIG. 4, on correlation desired to be excluded in the m×m score matrix obtained from the score function of the self-attention.

Further, Multi-Head Self-Attention (MHSA) may refer to a process of performing masked self-attention multiple times in parallel. That is, it means that, for a positive integer h, H different matrices {Q, K, V} are generated using h different matrices {W_{Q}, W_{K}, W_{V}}, and then used. Here, the result of multi-head self-attention may have a form in which h result matrices obtained from respective masked self-attention computations are concatenated.

Furthermore, Grouped Multi-Query Self-Attention (GMQSA) is a modification of multi-head self-attention. Here, the multi-head self-attention generates and uses h different matrices {Q, K, V}, whereas grouped multi-query self-attention refers to a method of generating, for a positive integer g less than h, g matrices {K, V}, and then allowing h matrices Q to share the g matrices in the form of a group.

Furthermore, Multi-Query Self-Attention (MQSA) is a modification of the multi-head self-attention. Unlike the multi-head self-attention that generates and uses h different matrices {Q, K, V}, the multi-query self-attention refers to a method of generating a single set of {K, V} and allowing h matrices Q to share the single set of {K, V}.

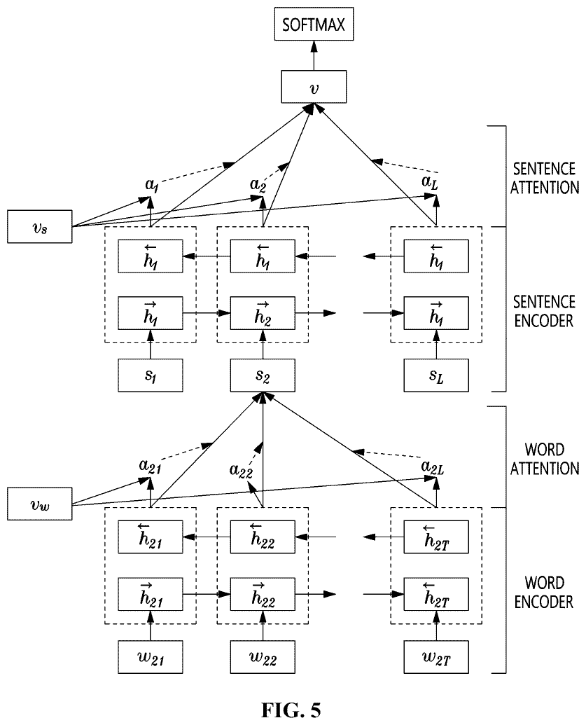

Further, FIG. 5 is a diagram illustrating an example of hierarchical attention.

Referring to FIG. 5, Hierarchical Attention (HA) may gather data at various levels of abstraction within an input sequence. Here, hierarchical attention may organize information hierarchically and aggregate data at various levels, such as word-level and sentence-level representations.

For example, FIG. 5 shows that attention between sentences and attention between words constituting each sentence occur, and the results of attention between words are hierarchically reflected in the corresponding sentence.

Also, Sparse Attention (SA) allocates attention weights only to some input elements other than all input elements. In other words, by focusing on specific elements, the sparse attention reduces computational complexity and enables the corresponding model to concentrate on relevant information, thereby improving efficiency.

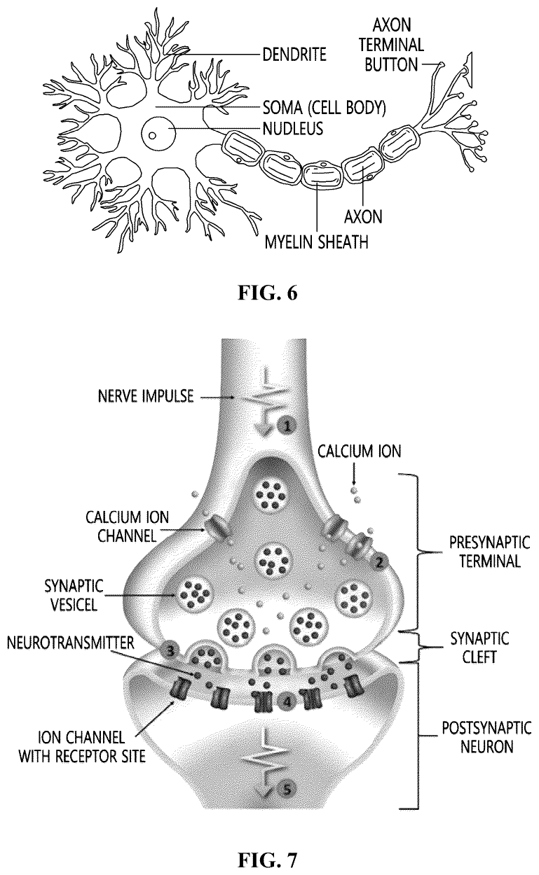

Hereinafter, a Brain-inspired Neural Network (BNN) will be described in detail with reference to FIGS. 6 to 8.

A BNN is a type of artificial neural network that models a neural system within the biological brain, and has been inspired and designed by the operational mechanisms of neurons and synapses that make up the brain's neural network. Unlike other artificial neural networks, the BNN emphasizes processing and transmitting temporal information through the exchange of electrical signals. Therefore, because the BNN is suitable for temporal information processing, and is particularly useful for processing real-time data or detecting changes over time, the BNN can be utilized in various application fields such as sensor data processing, pattern recognition, and temporal information processing.

Referring to FIG. 6, a BNN neuron may have a structure including detailed components such as a soma, a dendrite, an axon, and an axon terminal. Further, the neuron and the detailed components may have heterogeneous features.

Referring to FIG. 7, a BNN synapse corresponds to a junction that connects the terminal of a presynaptic neuron and the front end of a postsynaptic neuron. For example, the BNN synapse may have a structure in which neurotransmitters are released from the terminal of the presynaptic neuron, and absorbed at the front end of the postsynaptic neuron depending on the dynamics of neurotransmitter receptors and ion channels.

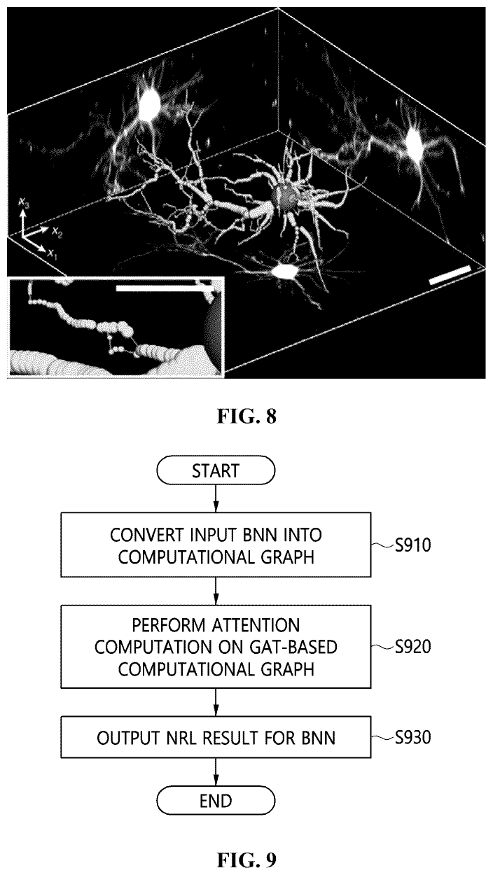

Here, the BNN neuron (or detailed components) and synapse may have features related to a three-dimensional (3D) geometric space. Accordingly, the BNN neuron may be represented in the 3D geometric space, as illustrated in FIG. 8.

In this case, the soma of the neuron may perform computation according to time-dependent dynamics. Representative dynamic models may include Leaky-Integrate and Fire (LIF), Izhikevich, or Hodgkin-Huxley models.

For example, the soma that performs computation based on LIF dynamics may perform computation in accordance with Equation (1) with respect to the membrane potential state variable V(t), resting membrane potential Vᵣₑₛₜ, an input current signal I(t), ion channel resistance R, and cell membrane capacitance C.

$${τ}_{m} \frac{\partial V ( t )}{\partial t} = - [ V ( t ) - {V}_{rest} ] + RI ( t ) , {τ}_{m} = RC \qquad ( 1 )$$

Also, the dendrite of the neuron may perform computation in accordance with Equation (2) with respect to an external current iₑₓₜ(x, t) injected into location x, current term iₖ(t) flowing through an ion channel k, and unit resistance rₓ at location x.

$$\frac{1}{{r}_{x}} \frac{{\partial }^{2} V ( x , t )}{\partial {x}^{2}} = c \frac{\partial V ( x , t )}{\partial t} + {\sum }_{k} {i}_{k} ( x , t ) - {i}_{ext} ( x , t ) \qquad ( 2 )$$

Also, assuming that the axons of the neuron are uniformly separated by segments wrapped with myelin of length Δx, a state variable Vₙ(x, t) within the nodes of Ranvier may be computed in accordance with Equation (3) with respect to Rₓ=rₓΔx.

$$C \frac{\partial {V}_{n} ( x , t )}{\partial t} = \frac{1}{{R}_{x}} [ {V}_{n + 1} ( x , t ) - 2 {V}_{n} ( x , t ) + {V}_{n - 1} ( x , t ) ] - {\sum }_{k} {I}_{k , n} ( x , t ) \qquad ( 3 )$$

Further, computation at the synapse may be performed in accordance with Equation (4), with respect to current I_{syn}, conductivity g_{syn}(t), the reversal potential E_{syn}, and Δtᵢ^{(f)}, which is the time it takes for an i-th spike signal generated at time tᵢ^{(f)} in the presynaptic neuron to reach an axon terminal.

$${I}_{syn} ( t ) = {g}_{syn} ( t ) ( V ( t ) - {E}_{syn} ) \\ {g}_{syn} ( t ) = {\sum }_{i} {\overline{g}}_{syn} exp [ - \{ \frac{t - ( {t}_{i}^{( f )} + Δ {t}_{i}^{( f )}}{τ} \} ] Θ ( t - ( {t}_{i}^{( f )} + Δ {t}_{i}^{( f )} ) ) \qquad ( 4 )$$

Here, in addition to the examples corresponding to Equation (1) to Equation (4), computation of processing electrical signals in all elements (e.g., axon terminals) represented by a state variable that can vary with time may occur at BNN.

Hereinafter, embodiments of the present disclosure will be described in detail with reference to the attached drawings.

FIG. 9 is an operation flowchart illustrating a method for analyzing a brain-inspired neural network based on network representation learning according to an embodiment of the present disclosure.

Referring to FIG. 9, in the method for analyzing a brain-inspired neural network based on network representation learning according to an embodiment of the present disclosure according to the embodiment of the present disclosure, an apparatus for analyzing a brain-inspired neural network converts an input brain-inspired neural network into a computational graph at step S910.

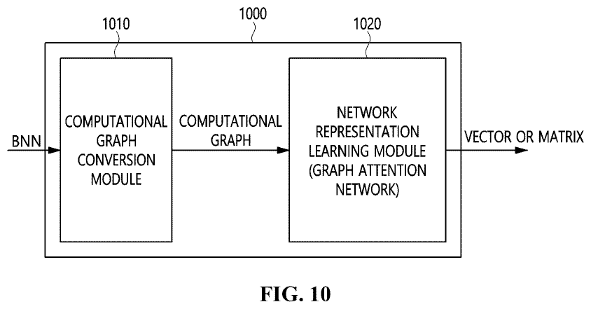

Computation at the brain-inspired neural network (BNN) may occur in all elements represented by the state variable that can vary with time, such as a neuron, a synapse, a soma, and an axon. Therefore, to perform BNN analysis, the present disclosure is intended to present a new network representation learning (NRL) framework 1000, such as that illustrated in FIG. 10, and an apparatus for utilizing the NRL framework. In order to analyze a computational model through the NRL, the NRL framework 1000 according to the present disclosure utilizes a computational graph and a graph attention network.

In detail, referring to FIG. 10, the BNN is input to a computational graph conversion module 1010 and converted into a computational graph. The computational graph obtained as a result of the conversion is used as the input of a network representation learning module 1020, and the representation of the BNN may be learned. Because the neuron and synapse of the BNN may function as computational elements and have various features, they cannot be sufficiently represented using only a simple graph. Therefore, the present disclosure adopts and uses a computational graph so as to sufficiently represent the complexity of the BNN.

Here, the computational graph may be composed of computational nodes corresponding to a neuron node, a soma node, a dendrite node, an axon node, and a synapse node.

Here, since the neuron and synapse of the BNN exhibit unique operations different from those of ANN, the present disclosure may handle not only a neuron but also a synapse as the computational nodes of the computational graph to represent the BNN by the computational graph.

Also, the present disclosure may reflect various features of BNN neurons and synapses, including an operation type, number of ion channels, a biological region, biological morphology, an activity pattern, and geometric properties.

For example, Table 1 shows common features that computational nodes according to the present disclosure may have.

TABLE 1

| Features | Data type |
|---|---|
| Node type | String |
| Unique identification number for each node type | Integer |
| Input type of node | String |
| List vector of input sizes of node | Vector of Integer |
| Output type of node | String |
| List vector of output sizes of node | Vector of Integer |
| List vector of node types of input computational node | Vector of String |
| List vector of unique identification numbers for respective | Vector of Integer |
| node types of input computational node | |
| List vector of node types of output computational node | Vector of String |
| List vector of unique identification numbers for respective | Vector of Integer |
| node types of output computational node | |
| List vector of multidimensional geographic feature names | Vector of String |
| List vector of multidimensional geographic feature values | Vector of Float |
| Computation for each computational node type | String |
| Computation sequence vector | Vector of String |
| List vector of computation parameter names | Vector of String |
| List vector of computation parameter values | Vector of Integer of Float |
| List vector of required computation resource names | String |
| List vector of required computation resource values | Vector of Integer of Float |
| Others | . . . |

Here, referring to Table 1, computational nodes according to the present disclosure may correspond to the string type.

For example, when the features of the computational nodes are represented, basic feature vectors of the computational nodes may be used partially, entirely or in an extended form.

Below, features within the basic feature vector of each computational node will be described in detail.

First, the node type may correspond to a neuron, a soma, a dendrite, an axon, a synapse, or the like.

The node input and output type may correspond to a current, a real number, a multidimensional vector, a multidimensional matrix, a tensor, or the like.

The input and output size of each node may correspond to the length of each dimension.

Also, the names of multidimensional geographic features may correspond to length, width, height, 3D vector, a quaternion, or the like.

Further, the computation for each node type may correspond to computation of a neuron, a soma, a dendrite, an axon, a synapse, or the like.

Further, the computation sequence vector may correspond to a vector obtained by tokenizing, in order, a text sequence that implements or represents a given computation determined by the computation type for each node type using a programming framework, programming language, compiler intermediate representation, development pattern, or data representation format, while preserving the functionality and flow of the computation. In this case, tokenization may refer to a technique used in natural language processing.

For example, as the programming framework, PyTorch, TensorFlow, Keras or the like may be used. As the programming language, Python, MATLAB, C, C++, CUDA, JAVA, JavaScript, or assembly may be used. As the compiler intermediate representation, TOSA, LLVM, Intermediate Representation (IR), SPIR-V, Microsoft Intermediate Language (MSIL), WebAssembly, Three Address Code (TAC), HLSL/GLSL, or the like may be used. As the development pattern, Higher-Order Components (HOC), Mixins or the like may be used. As the data representation format, a binary format, a quantum spin format or the like may be used.

Further, the required computation resources may correspond to input/output size, computation execution time, memory usage, or the like.

Below, the computation for each node type is described in detail.

First, neuron computation and soma computation may correspond to LIF, Izhikevich, Hodgkin-Huxley, or the like.

Also, dendrite computation may correspond to the following Equation (5):

$$\frac{1}{{r}_{x}} \frac{{\partial }^{2} V ( x , t )}{\partial {x}^{2}} = c \frac{\partial V ( x , t )}{\partial t} + {\sum }_{k} {i}_{k} ( x , t ) - {i}_{ext} ( x , t ) \qquad ( 5 )$$

Further, axon computation may correspond to the following Equation (6):

$$C \frac{\partial {V}_{n} ( x , t )}{\partial t} = \frac{1}{{R}_{x}} [ {V}_{n + 1} ( x , t ) - 2 {V}_{n} ( x , t ) + {V}_{n - 1} ( x , t ) ] - {\sum }_{k} {I}_{k , n} ( x , t ) \\ {cr}_{x} \frac{\partial V ( x , t )}{\partial t} = \frac{{\partial }^{2} V ( x , t )}{\partial {x}^{2}} - {r}_{x} [ V ( x , t ) - {E}_{L} ] - {r}_{x} {i}_{ion} ( x , t ; {V}_{past} ) \\ where \\ {i}_{ion} ( x , t ; {V}_{past} ) = {g}_{Na} {m}_{Na}^{3} ( x , t ) {h}_{Na} ( x , t ) [ V ( x , t ) - {E}_{Na} ] - {g}_{K} {m}_{K}^{4} [ V ( x , t ) - {E}_{K} ] \qquad ( 6 )$$

Furthermore, synapse computation may correspond to the following Equation (7):

$${I}_{syn} ( t ) = {g}_{syn} ( t ) ( V ( t ) - {E}_{syn} ) \\ where \\ {g}_{syn} ( t ) = {\sum }_{i} {\overline{g}}_{syn} exp [ - \{ \frac{t - ( {t}_{i}^{( f )} + Δ {t}_{i}^{( f )}}{τ} \} ] Θ ( t - ( {t}_{i}^{( f )} + Δ {t}_{i}^{( f )} ) ) \\ {I}_{syn} ( t ) = {g}_{syn} ( t ) ( V ( t ) - {E}_{syn} ) \\ where \\ {g}_{syn} ( t ) = {\sum }_{i} {\overline{g}}_{syn} exp [ - \{ \frac{t - ( {t}_{i}^{( f )} + Δ {t}_{i}^{( f )}}{τ} \} ] {𝔼}_{i} [ \begin{matrix}\text{?} \\ {g}_{syn}\end{matrix} ] Θ ( t - ( {t}_{i}^{( f )} + Δ {t}_{i}^{( f )} ) ) \\ and \\ {𝔼}_{i} [ \begin{matrix}\text{?} \\ {g}_{syn}\end{matrix} ] = {\sum }_{j} {w}_{j} exp [ - \{ \frac{t - ( {t}_{i}^{( f )} + Δ {t}_{i}^{( f )}}{\text{?}} \} ] , {\sum }_{j} {w}_{j} = 1 for 0 \leq {w}_{j} \leq 1 \\ {I}_{syn} ( t ) = {g}_{syn} ( t ) ( V ( t ) - {E}_{syn} ) \\ where \\ {g}_{syn} ( t ) = {g}_{max} {m}_{syn}^{{p}_{k}} ( t ) {h}_{syn}^{{q}_{k}} ( t )$$

$$\text{?} \text{indicates text missing or illegible when filed}$$

Here, the soma node, the dendrite node, and the axon node may belong to any one neuron node.

Here, the neuron node may include features corresponding to a firing pattern, firing frequency, a list of firing times, an associated region, the type of associated neural network, a neuron type, a list vector of computational nodes constituting the neuron node, and a list vector of unique identification numbers for respective computational nodes constituting the neuron node.

That is, the neuron node may include additional features in addition to the features in the basic feature vector of the computational node.

For example, the neuron node may include, as the firing pattern belonging to the string type, single firing, periodic firing, bursting firing, adaptive firing, inhibitory firing, or post-initialization firing. The neuron node may include firing frequency belonging to the float type. In addition, the neuron node may include a list of firing times, corresponding to the ‘vector of integer’ type. The neuron node may include, as the associated region belonging to the string type, CA1, CA2, CA3, DG, SUB, V1, V2, V3, V4, or MT. The neuron node may include, as the type of associated neural network belonging to the string type, a fully connected type, a convolutional type, or a recurrent type. The neuron node may include, as a neuron type belonging to the string type, pyramidal, granule, stellate, substantia, or Purkinje. Also, the neuron node may include a list vector of (computational) node types of components constituting the neuron, which belongs to the ‘vector of string’ type. Furthermore, the neuron node may include a list vector of unique identification numbers of respective (computational) node types of components constituting the neuron, which belongs to the Vector of Integer type.

Here, the soma node, the dendrite node, and the axon node may include features corresponding to identification numbers for respective node types of the associated neuron node.

That is, the soma node, the dendrite node, and the axon node, which are components constituting the neuron node, may have additional features in addition to features in the basic feature vector of the computational node.

For example, the components may have identification numbers for respective node types of associated neuron, which belong to the Integer type.

Here, the soma node may include features corresponding to a firing pattern, firing frequency, and a list vector of firing times

That is, the soma node may include additional features in addition to features in the basic feature vector of the computational node.

For example, the soma node may include, as the firing pattern belonging to the string type, single firing, periodic firing, bursting firing, adaptive firing, inhibitory firing, or post-initialization firing. Further, the soma node may include firing frequency belonging to the float type. Furthermore, the soma node may have a list of firing times, belonging to the Vector of Integer type.

In this case, the synapse node may include features corresponding to a list vector of difference values between firing times of presynaptic and postsynaptic neurons and the average value of the difference values when an input computational node and an output computational node are configured to correspond to the neuron node, the soma node, the dendrite node, and the axon node; the transmission efficacy/weight of neurotransmitters in the synapse; and the type of synapse.

In other words, the synapse node may have additional features in addition to features in the basic feature vector of the computational node.

For example, the synapse node may have a list vector of the difference values between firing times of the presynaptic and postsynaptic neurons, which belong to the ‘vector of integer’ type. Here, the synapse node may additionally have the list vector when the types of both the input computational node and the output computational node are the neuron or the components thereof.

Further, the synapse node may have the average value of the difference values between firing times of the presynaptic and postsynaptic neurons, which belong to the float type. Here, the synapse node may additionally have the average value of the difference values when the types of both the input computational node and the output computational node are the neuron or the components thereof.

In addition, the synapse node may have the transmission efficacy or weight of neurotransmitters in the synapse, which belongs to the float type, and the type of the synapse. Also, the synapse node may also have excitatory or inhibitory as the type of synapse belonging to the string type.

Further, in the method for analyzing a brain-inspired neural network based on network representation learning according to the embodiment of the present disclosure according to the embodiment of the present disclosure, the apparatus for analyzing a brain-inspired neural network performs an attention computation on the computational graph based on a Graph Attention Network (GAT) at step S920.

Here, the graph attention network may perform the attention computation by combining hierarchical attention with masked self-attention.

That is, the present disclosure proposes a new type of GAT structure in which hierarchical attention and masked self-attention are combined in accordance with a complicated BNN structure.

Such a structure may reflect two notable aspects of a BNN. First, the BNN neuron exhibits a hierarchical structure and is composed of multiple parts such as a soma, a dendrite, and an axon. Second, unlike a neuron and components thereof, which need to be handled at different organizational hierarchical levels, a synapse needs to be handled together at the same organizational hierarchical level as the neuron and the components thereof.

Hereinafter, an attention computation process according to the present disclosure will be described in detail.

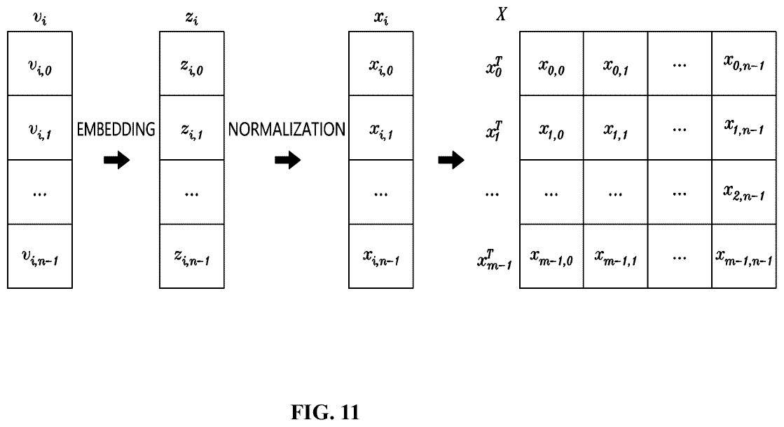

First, referring to FIG. 11, in the present disclosure, a neuron, a soma, a dendrite, an axon, and a synapse constituting a BNN are treated as a computational node v. When the number of computational nodes constituting the BNN is m, the BNN is input to obtain the feature vector thereof vᵢ (where 0≤i<m) based on the computational node feature vector described in Table 1.

Here, vᵢ has the feature of having a string type, other than an integer or float type. Therefore, embedding technology of converting a string into a number may be applied, and thus the feature vector composed of only numbers zᵢ (where 0≤i<m) may be obtained. For example, the feature vector zᵢ may be obtained by utilizing embedding technology such as Word2Vec that is widely used in natural language processing.

Thereafter, xᵢ (where 0≤i<m) may be obtained by performing normalization on the feature vector zᵢ. Here, normalization refers to normalization technology widely used in artificial intelligence, and may use, for example, batch normalization, RMS normalization, or the like.

When xᵢ is obtained through normalization, xᵢ^{T} may be sequentially stacked, and thus a set matrix X of the feature vectors that can be applied in the form of input to self-attention may be obtained. Here, when different computational nodes have different numbers of features, n may be the number of features of the computational node having the maximum number of features. Further, an X element space, occurring as a computational node having a small number of features is present, may be filled using padding.

Here, the present disclosure may use a structure similar to the structure used in Transformer, BERT, GPT, or LLAMA widely used as a basic NRL framework. Therefore, in order to analyze a correlation between computational nodes, the basic NRL framework may utilize the set matrix X of the feature vectors, obtained by stacking the feature vectors xi, and masked self-attention or a modification thereof.

Here, the modifications of masked self-attention represent application of a masking technique to Self-Attention (SA), Bi-Directional Self-Attention (BSA), Multi- Head Self-Attention (MHSA), Grouped Multi-Query Self-Attention (GMQSA), or Multi-Query Self-Attention (MQSA).

Hereinafter, it is assumed that, for convenience of description, bi-directional masked self-attention is used. However, the present disclosure may be configured using masked self-attention or other modifications.

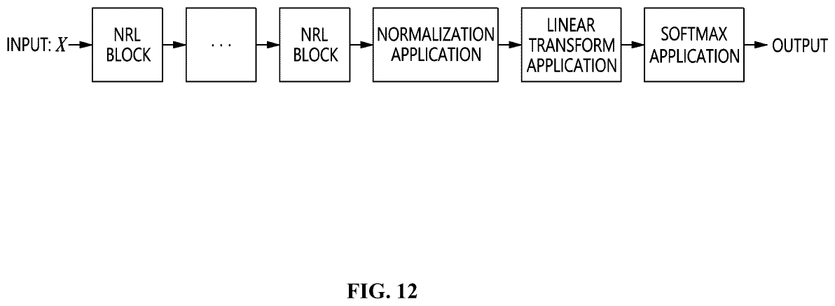

FIG. 12 illustrates a basic NRL framework according to the present disclosure, which may be configured based on NRL blocks.

Here, as shown in FIG. 12, when multiple NRL blocks are used, respective NRL blocks may have different learnable parameters. Also, the input of each NRL block may be the output of a previous NRL block. Here, the input of a first NRL block may be a set matrix X of feature vectors, and the output of the last NRL block may be the output of the basic NRL framework of the present disclosure, to which normalization, linear transform, and softmax are sequentially applied.

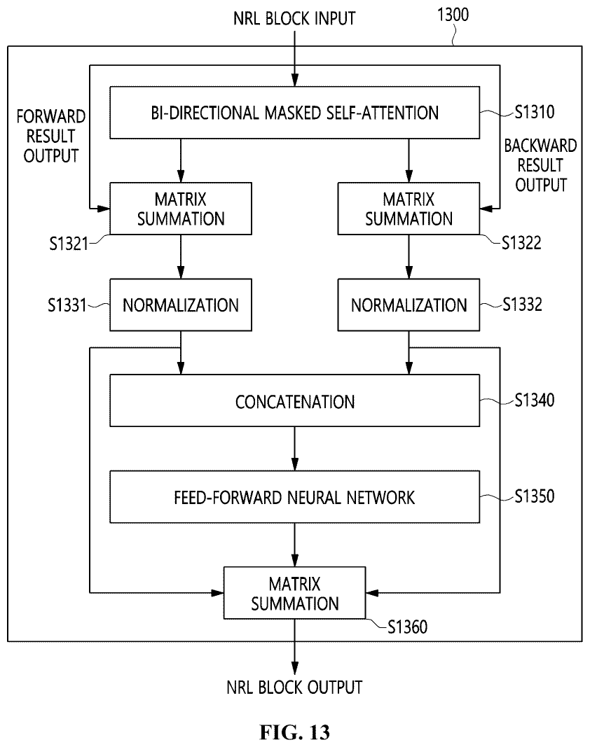

Here, one NRL block may be operated, as illustrated in FIG. 13.

Below, an operating process of the NRL block will be described in detail with reference to FIG. 13.

Referring to FIG. 13, an NRL block 1300 may be configured by combining bi-directional masked self-attention (S1310), normalization (S1331 and S1332), a feed-forward neural network (S1350), and the like.

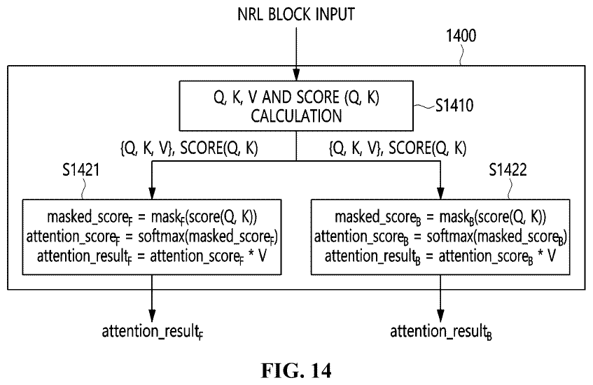

Here, the bi-directional masked self-attention (S1310) may be operated, as illustrated in FIG. 14.

Referring to FIG. 14, a bi-directional masked self-attention block 1400 may receive m×n NRL block input and calculate m×d two-dimensional (2D) matrices {Q, K, V} at step S1410.

Here, {Q, K, V} may be calculated based on Q=X*W_{Q}, K=X*W_{K}, and V=X*W_{V} using n×d 2D matrices {W_{Q}, W_{K}, W_{V}}. For convenience of description, it may be assumed that d has the same value as n in the present disclosure.

Thereafter, the bi-directional masked self-attention block 1400 may calculate attention_scores for forward/backward directions by utilizing {Q, K}, a score function, a mask function, and a softmax function at steps S1421 and S1422.

Here, the score function generally refers to a widely used score function, and may be implemented with, for example, a dot, scaled dot, general, concat, or location- based function.

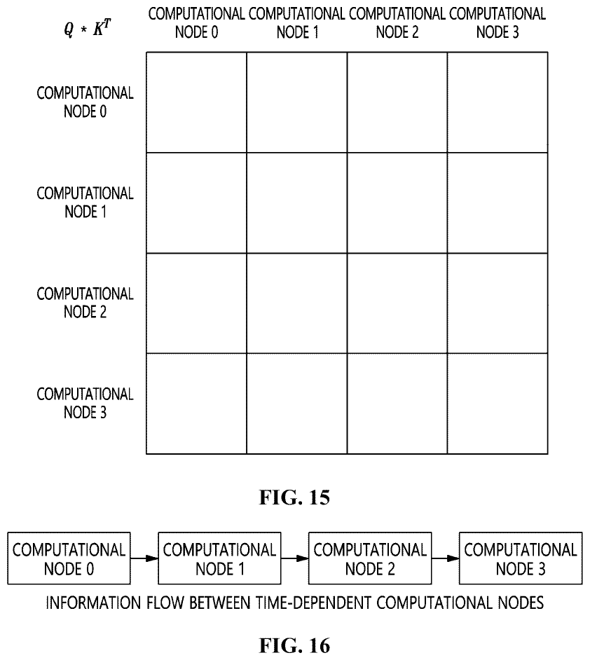

In this case, during a process of calculating attention_scores, correlations between computational nodes may be represented by a 2D matrix through the score function, as illustrated in FIG. 15. For example, when the dot function is used, the matrix may be the result of computation of Q*K^{T}.

Here, the result of the score function may be an m×m square matrix, and the indices of row and column may match indices i of respective computational nodes. FIG. 15 illustrates the case of m=4.

Here, masked self-attention may reflect an information flow between time-dependent computational nodes based on the sequential progression starting from the neuron node and corresponding to the dendrite node, the soma node, the axon node, and the synapse node.

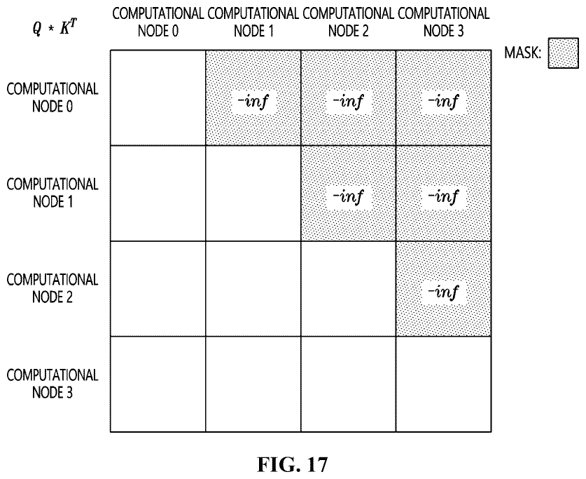

For example, the mask function used by the bi-directional masked self-attention of the basic NRL framework according to the present disclosure may reflect an information flow between time-dependent computational nodes, as illustrated in FIG. 16.

Here, the mask function may have forward directionality and backward directionality.

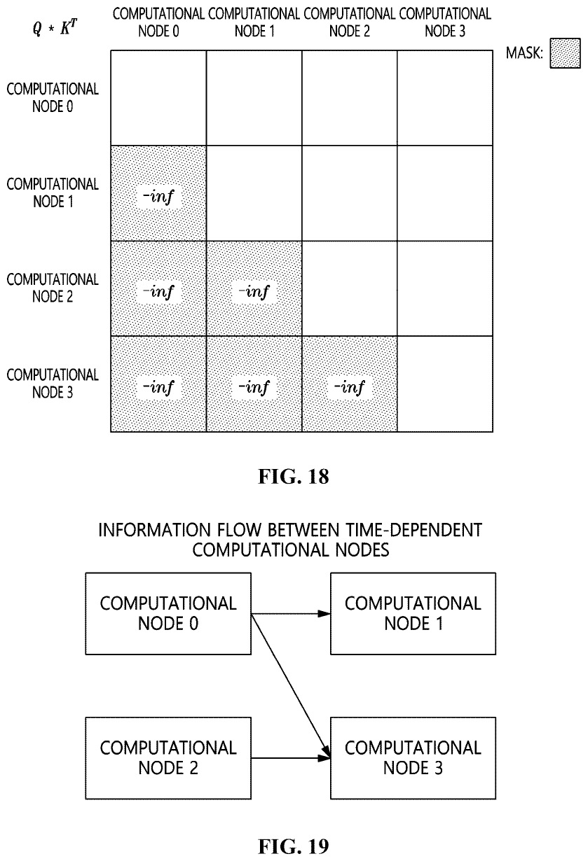

For example, the bi-directional masked self-attention may calculate masked scores (masked_scores), as illustrated in FIGS. 17 and 18, by performing mask_{F}(score(Q, K)) and mask_{B}(score(Q, K)) in parallel using mask_{F}(⋅) that is a forward mask function and mask_{B}(⋅) that is a backward mask function.

Referring to FIGS. 17 and 18, each mask function may correspond to a function that overlays −inf values onto the result matrix of the score function (e.g., Q*K^{T}).

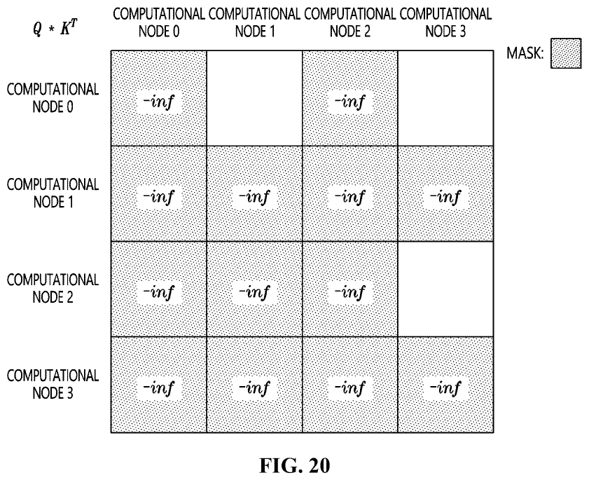

Here, FIG. 19 illustrates a parallel flow in which computational node 0 and computational node 2 are parallel to each other, and FIG. 20 is a diagram illustrating an example of the masking method in FIG. 19.

That is, mask_{F}(⋅) and mask_{B}(⋅) may reflect both masking methods for a serial flow and a parallel flow, as illustrated in FIGS. 16 to 20.

Here, referring to steps S1421 and S1422 in FIG. 14, the bi-directional masked self-attention of the basic NRL framework according to the present disclosure may calculate attention_scores by executing a softmax function on the masked_scores. Thereafter, the bi-directional masked self-attention may generate output matrix attention results (attention_results) by performing a matrix multiplication on the attention_scores and V.

Referring back to FIG. 13, the NRL block 1300 may add each of the m×d attention_results, which are the results of the bi-directional masked self-attention S1310, to the NRL block input using matrix summation at steps S1321 and S1322.

Thereafter, the NRL block 1300 may perform normalization on the result matrices of the matrix summation at steps S1331 and S1332, and may obtain an m×2d matrix by concatenating the result matrices of normalization at step S1340.

Thereafter, the obtained matrix may be input to the feed-forward neural network at step S1350.

Here, it may be assumed that the feed-forward neural network receives the m×2d matrix and outputs an m×d matrix.

In this case, the feed-forward neural network at step S1350 is a neural network widely used in artificial intelligence field, and examples thereof may be feed-forward neural networks widely used in Transformers, BERT, GPT, LLAMA or the like.

Thereafter, the NRL block 1300 may perform matrix summation on the output matrix of the feed-forward neural network and normalization result matrices obtained immediately before the feed-forward neural network process is performed at step S1360.

Here, the result matrix of the matrix summation may be the output of the NRL block 1300.

If it is desired to learn representations for components of the feature vector v of the computational node using a basic NRL framework, the basic NRL framework may be used without change by differently configuring the set matrix X of the feature vector.

Here, masked self-attention may be applied in units of a computational node corresponding to each element in an N×N matrix indicating vectors corresponding to the computational nodes.

An important point when learning representations for the components of the feature vector of the computational node is that each row in an X matrix needs to be configured to correspond to one individual feature.

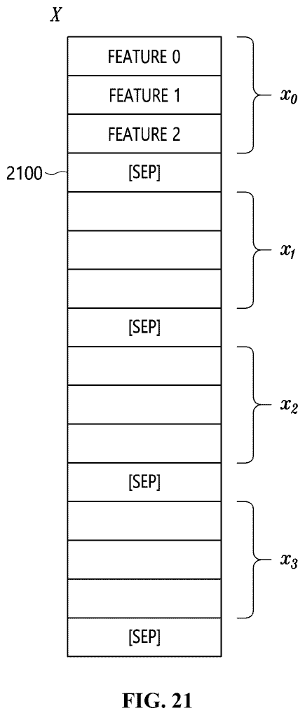

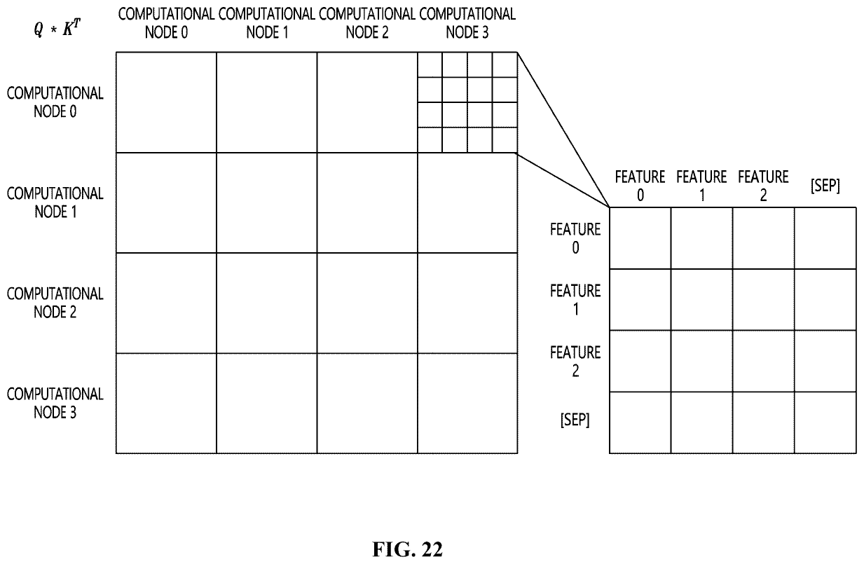

For example, FIGS. 21 and 22 illustrate an example in which when the dimension of the feature vector xᵢ is 3, the feature vectors are separated by a SEP token 2100.

Here, FIG. 21 illustrates a method of configuring X when learning representations for components of the feature vector v of the corresponding computational node, and FIG. 22 illustrates the result matrix Q*K^{T} of a score function when X configured as illustrated in FIG. 21 is used.

Here, as illustrated in FIG. 21, four 3D feature vectors xᵢ and the [SEP] token 2100 are used, and thus a 16×16 matrix may be configured, as illustrated in FIG. 22. The four row or columns illustrated in FIG. 22 may match computational node indices, and one row or column may match the corresponding feature or the [SEP] token 2100.

Here, masking illustrated in FIGS. 17, 18 and 20 may be applied in units of a computational node. Therefore, in FIG. 22, masking may be applied in units of 4×4 blocks which are separated by the [SEP] token 2100.

Also, in the present disclosure, masking may also be applied to features irrelevant to each other.

For example, because a multidimensional geographic feature name and a multidimensional geographic feature value are closely associated with each other in the basic feature vector of the computational node, they may not be masked. On the other hand, because the output type of the node and the multidimensional geographic feature name are not associated with each other, they may be masked.

In this case, hierarchical attention may be performed by applying the hierarchical structure of the neuron node.

For example, after the above-described masking, hierarchical attention may be performed in the same manner as the basic NRL framework process of the present disclosure to learn correlations between the computational nodes. However, the basic RL framework may have a disadvantage in that correlations between computational nodes that do not have correlations are unnecessarily learned.

Therefore, the present disclosure may compensate for the disadvantage of the basic NRL framework that performs unnecessary computation by utilizing the hierarchical NRL framework.

For this, the NRL framework may be configured in consideration of the hierarchical relationship between computational nodes without utilizing the structure used in a Transformer, BERT, GPT, LLaMA or the like.

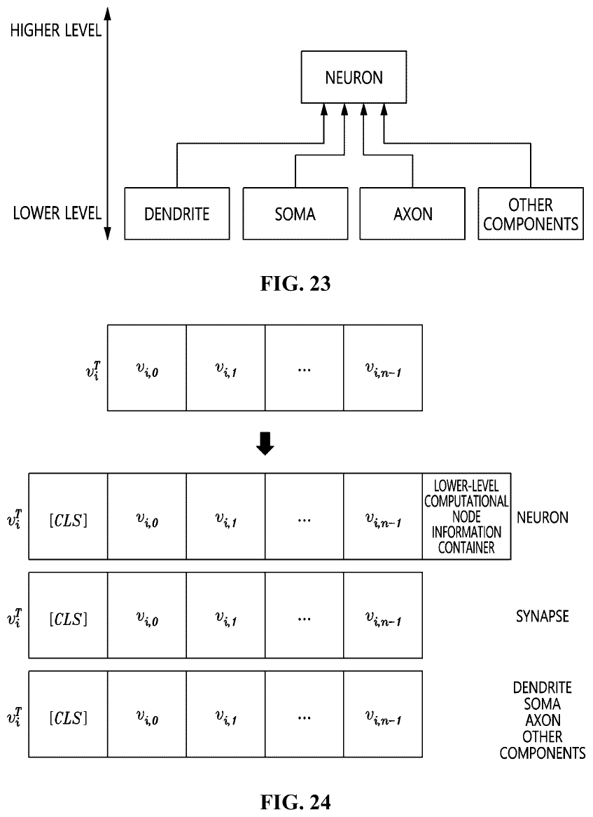

For example, as illustrated in FIG. 23, the hierarchical NRL framework according to the present disclosure may subdivide a neuron into groups of components such as a dendrite, a soma, an axon, and other components.

That is, FIG. 23 illustrates the hierarchical relationship between the neuron and components thereof.

Here, the hierarchical attention may reflect the information of lower-level computational nodes in a higher-level computation node based on a Classification (CLS) token.

For example, referring to FIG. 24, the hierarchical NRL framework according to the present disclosure may generate \dot{v}ᵢ in which the [CLS] token is added to an existing feature vector \dot{v}ᵢ in consideration of a hierarchical structure.

When a computational node matching \dot{v}ᵢ is a neuron, a new feature vector \dot{v}ᵢ may be configured by adding a container into which information of the lower-level computational nodes can be stored. Thereafter, \dot{v}ᵢ may be embedded and normalized, and then X may be configured and used based on the result of embedding and normalization.

Here, the [CLS] token may be used to contain the integrated information of v\dot{v}ᵢ.

For example, the container in which the information of the lower-level computational nodes can be stored corresponds to a container in which a value corresponding to the position of the [CLS] token is stored in a result matrix that is output by inputting the set matrix of feature vectors of the lower-level computational nodes to the NRL block.

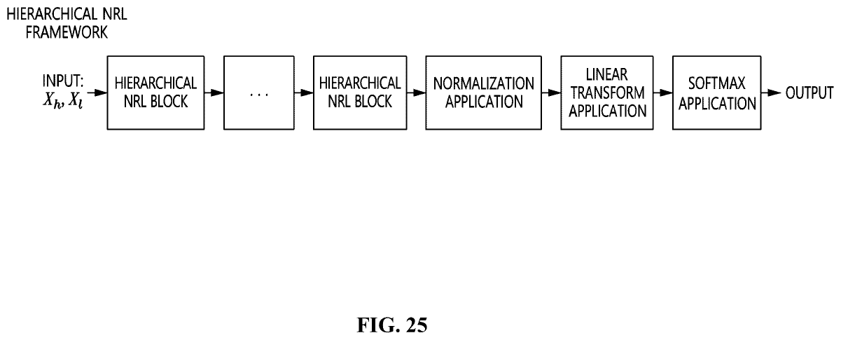

FIG. 25 illustrates a hierarchical NRL framework according to the present disclosure, which may be constructed based on a hierarchical NRL block.

Here, as illustrated in FIG. 25, when multiple hierarchical NRL blocks are used, the hierarchical NRL blocks may have different learnable parameters. Also, the input of each of the hierarchical NRL blocks may be the output of the previous hierarchical NRL block. Here, the input of a first hierarchical NRL block may be the set matrices Xₕ and X₁ of feature vectors. Here, Xₕ may refer to the feature vector set matrix of a neuron node and synapse nodes, and X may refer to the feature vector set matrix of a dendrite node, a soma node, an axon node, and other computational nodes, which are components of the neuron node. Also, the output of the last hierarchical NRL block may be the output of the hierarchical NRL framework according to the present disclosure to which normalization, linear transform, and softmax are sequentially applied.

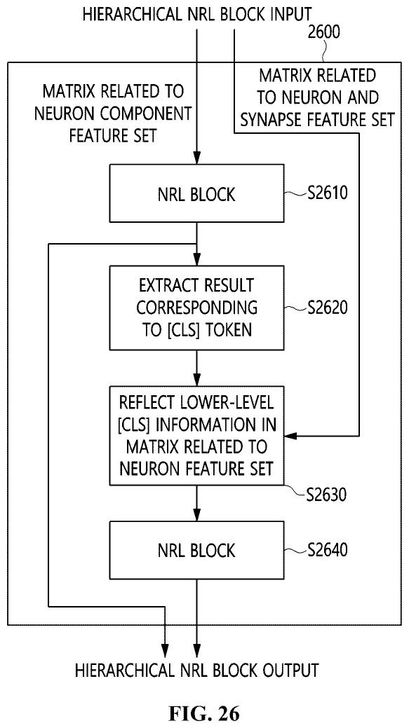

Here, each hierarchical NRL block may be operated, as shown in FIG. 26.

Hereinafter, an operating process of the hierarchical NRL block will be described in detail with reference to FIG. 26.

Referring to FIG. 26, one hierarchical NRL block 2600 may be configured by combining two NRL blocks.

First, a first NRL block may process the feature vector set matrix of dendrite, soma, axon, and other computational nodes, which are the components of the neuron at step S2610.

Next, a result at the position of a [CLS] token may be extracted from the matrix output from the first NRL block at step S2620, and may then be reflected in a matrix related to the neuron feature set at step S2630.

Thereafter, a second NRL block may process the feature vector set matrix of the neuron node and synapse nodes at step S2640.

In this way, the output of the hierarchical NRL block 2600 may be composed of the outputs of two NRL blocks.

Also, in the method for analyzing a brain-inspired neural network based on network representation learning according to the embodiment of the present disclosure, the apparatus for analyzing the brain-inspired neural network outputs the result of network representation learning for the brain-inspired neural network based on attention computation at step S930.

Here, the result of network representation learning may correspond to the N×N matrix indicating a vector corresponding to the computational node, and each element in the N×N matrix may be implemented with an M×M matrix indicating feature vectors for the corresponding computational node.

Here, feature vectors for the corresponding computational node may be separated based on a SEP token.

For example, learning of the NRL frameworks according to the present disclosure may be performed in such a way as to randomly remove X or elements of {Xₕ, X₁}, apply the randomly removed X or elements to the NRL frameworks, as input, and allow the NRL frameworks to learn the task of completely recovering the removed elements. Thereafter, the basic NRL framework according to the present disclosure on which learning has been completed may correspond to the result of learning of the correlations between computational nodes, such as a neuron, a soma, a dendrite, an axon, and a synapse constituting a BNN is learned.

By means of the method for analyzing a brain-inspired neural network based on network representation learning, the brain-inspired neural network can be automatically analyzed through a network representation learning framework.

Further, the method can analyze the learning trend of a brain-inspired neural network and utilize the learning trend for artificial intelligence and brain-inspired computing in the field of neuroscience.

Furthermore, the method can facilitate the reconstruction of brain structures and the simulation of brain functions in neuroscience, thereby enhancing the understanding of how the biological brain processes information, how neural pathways are interconnected, and how these interconnections affect behavior and cognitive functions, and the influence thereof on behavior and cognitive functions.

Furthermore, the method can be utilized for a computational graph optimization technique as the embedding module of a BNN computational graph, when configuring a compiler for executing a brain-inspired neural network on hardware designed for brain-inspired computing.

Additionally, the method can support the conversion and use of an AI model into a brain-inspired neural network to improve power efficiency during AI execution.

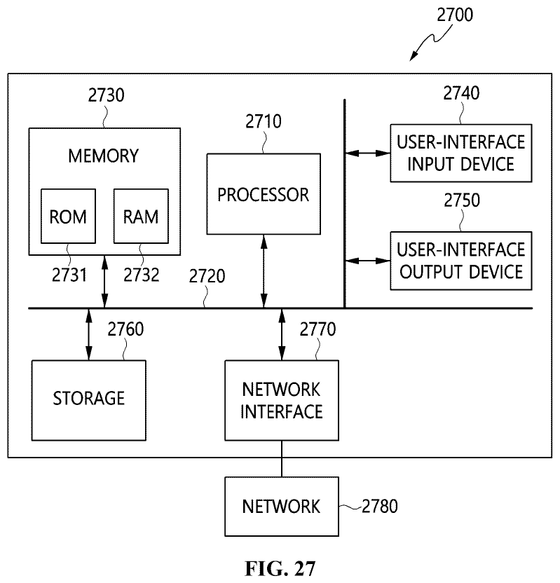

FIG. 27 is a diagram illustrating an apparatus for analyzing a brain-inspired neural network based on network representation according to an embodiment of the present disclosure.

Referring to FIG. 27, the apparatus for analyzing a brain-inspired neural network based on network representation according to the embodiment of the present disclosure may be implemented in a computer system such as a computer-readable storage medium. As illustrated in FIG. 27, a computer system 2700 may include one or more processors 2710, memory 2730, a user interface input device 2740, a user interface output device 2750, and storage 2760, which communicate with each other through a bus 2720. The computer system 2700 may further include a network interface 2770 connected to a network 2780. Each processor 2710 may be a Central Processing Unit (CPU) or a semiconductor device for executing programs or processing instructions stored in the memory 2730 or the storage 2760. Each of the memory 2730 and the storage 2760 may be any of various types of volatile or nonvolatile storage media. For example, the memory 2730 may include Read-Only Memory (ROM) 2731 or Random Access Memory (RAM) 2732.

Therefore, the embodiment of the present disclosure may be implemented as a non-transitory computer-readable medium in which a computer-implemented method or computer-executable instructions are stored. When the computer-readable instructions are executed by the processor, the computer-readable instructions may perform the method according to at least one aspect of the present disclosure.

Hereinafter, description is made on the assumption that each processor 2710 performs functions of the computational graph conversion module 1010 and the network representation learning module 1020.

First, the processor 2710 converts an input brain-inspired neural network into a computational graph.

Here, the computational graph may be composed of computational nodes corresponding to a neuron node, a soma node, a dendrite node, an axon node, and a synapse node.

Here, the computational nodes may correspond to a string type.

Here, the soma node, the dendrite node, and the axon node may belong to any one neuron node.

The neuron node may include features corresponding to a firing pattern, firing frequency, a list of firing times, an associated region, the type of associated neural network, a neuron type, a list vector of computational nodes constituting the neuron node, and a list vector of unique identification numbers for respective computational nodes constituting the neuron node.

Here, the soma node, the dendrite node, and the axon node may include features corresponding to identification numbers for respective node types of the associated neuron node.

Here, the soma node may include features corresponding to a firing pattern, firing frequency, and a list vector of firing times.

In this case, the synapse node may include features corresponding to a list vector of difference values between firing times of presynaptic and postsynaptic neurons when an input computational node and an output computational node are configured to correspond to the neuron node, the soma node, the dendrite node, and the axon node; the average value of the difference values between firing times of presynaptic and postsynaptic neurons when the input computational node and the output computational node are configured to correspond to the neuron node, the soma node, the dendrite node, and the axon node; the transmission efficacy/weight of neurotransmitters in the synapse; and the type of synapse.

Further, the processor 2710 performs an attention computation on the computational graph based on a Graph Attention Network (GAT).

The graph attention network may perform the attention computation by combining hierarchical attention with masked self-attention.

Here, hierarchical attention may be performed by applying the hierarchical structure of the neuron node.

The hierarchical attention may reflect the information of lower-level computational nodes in a higher-level computation node based on a Classification (CLS) token.

Here, masked self-attention may reflect an information flow between time-dependent computational nodes based on the sequential progression starting from the neuron node and corresponding to the dendrite node, the soma node, the axon node, and the synapse node.

Here, the masked self-attention may be applied in units of a computational node corresponding to each element in an N×N matrix indicating vectors corresponding to the computational nodes.

Furthermore, the processor 2710 outputs the result of network representation learning for the brain-inspired neural network based on the attention computation.

Here, the result of network representation learning may correspond to the N×N matrix indicating a vector corresponding to the computational node, and each element in the N×N matrix may be implemented with an M×M matrix indicating feature vectors for the corresponding computational node.

Here, feature vectors for the corresponding computational nodes may be separated based on a SEP token.

By means of the apparatus for analyzing a brain-inspired neural network based on network representation learning, the brain-inspired neural network can be automatically analyzed through a network representation learning framework.

Further, the apparatus can analyze the learning trend of a brain-inspired neural network and utilize the learning trend for artificial intelligence and brain-inspired computing in the field of neuroscience.

Furthermore, the apparatus can facilitate the reconstruction of brain structures and the simulation of brain functions in neuroscience, thereby enhancing the understanding of how the biological brain processes information, how neural pathways are interconnected, and how these interconnections affect behavior and cognitive functions, and the influence thereof on behavior and cognitive functions.

Furthermore, the apparatus can be utilized for a computational graph optimization technique as the embedding module of a BNN computational graph, when configuring a compiler for executing a brain-inspired neural network on hardware designed for brain-inspired computing.

Additionally, the apparatus can support the conversion and use of an AI model into a brain-inspired neural network to improve power efficiency during AI execution.

According to the present disclosure, a brain-inspired neural network can be automatically analyzed through a network representation learning framework.

Further, the present disclosure can analyze the learning trend of a brain-inspired neural network and utilize the learning trend for artificial intelligence and brain-inspired computing in the field of neuroscience.

Furthermore, the present disclosure can facilitate the reconstruction of brain structures and the simulation of brain functions in neuroscience, thereby enhancing the understanding of how the biological brain processes information, how neural pathways are interconnected, and how these interconnections affect behavior and cognitive functions, and the influence thereof on behavior and cognitive functions.

Furthermore, the present disclosure can be utilized for a computational graph optimization technique as the embedding module of a BNN computational graph, when configuring a compiler for executing a brain-inspired neural network on hardware designed for brain-inspired computing.

Additionally, the present disclosure can support the conversion and use of an AI model into a brain-inspired neural network to improve power efficiency during AI execution.

As described above, in the method and apparatus for analyzing a brain-inspired neural network based on network representation learning according to the present disclosure, the configurations and schemes in the above-described embodiments are not limitedly applied, and some or all of the above embodiments can be selectively combined and configured so that various modifications are possible.

What is claimed is:

1. A method for analyzing a brain-inspired neural network, the method being performed by an apparatus for analyzing the brain-inspired neural network, the method comprising:
converting an input brain-inspired neural network into a computational graph;
performing attention computation on the computational graph based on a graph attention network; and
outputting a result of network representation learning for the brain-inspired neural network based on the attention computation.

2. The method of claim 1, wherein the computational graph comprises computational nodes corresponding to a neuron node, a soma node, a dendrite node, an axon node, and a synapse node.

3. The method of claim 2, wherein the computational nodes correspond to a string type.

4. The method of claim 2, wherein the soma node, the dendrite node, and the axon node belong to any one neuron node.

5. The method of claim 4, wherein the neuron node comprises features corresponding to a firing pattern, firing frequency, a list of firing times, an associated region, a type of associated neural network, a neuron type, a list vector of computational nodes constituting the neuron node, and a list vector of unique identification numbers for respective computational nodes constituting the neuron node.

6. The method of claim 4, wherein the soma node, the dendrite node, and the axon node comprise features corresponding to the identification numbers for respective node types of an associated neuron node.

7. The method of claim 6, wherein the soma node comprises features corresponding to a firing pattern, firing frequency, and a list vector of firing times.

8. The method of claim 4, wherein the synapse node comprises features corresponding to:
a list vector of difference values between firing times of presynaptic and postsynaptic neurons when an input computational node and an output computational node are configured to correspond to the neuron node, the soma node, the dendrite node, and the axon node,
an average value of the difference values when the input computational node and the output computational node are configured to correspond to the neuron node, the soma node, the dendrite node, and the axon node,
transmission efficacy/weight of neurotransmitters in a synapse, and
a type of the synapse.

9. The method of claim 2, wherein the graph attention network performs the attention computation by combining hierarchical attention with masked self-attention.

10. The method of claim 9, wherein the hierarchical attention is performed by applying a hierarchical structure of the neuron node.

11. The method of claim 9, wherein the masked self-attention reflects an information flow between time-dependent computational nodes based on a sequential progression starting from the neuron node and corresponding to the dendrite node, the soma node, the axon node, and the synapse node.

12. The method of claim 11, wherein the masked self-attention is applied in units of a computational node corresponding to each element in an N×N matrix indicating vectors corresponding to the computational nodes.

13. The method of claim 2, wherein the result of the network representation learning corresponds to an N×N matrix indicating vectors corresponding to the computational nodes, and each element in the N×N matrix is implemented with an M×M matrix indicating feature vectors for a corresponding computational node.

14. The method of claim 13, wherein the feature vectors for the corresponding computational node are separated based on a separator (SEP) token.

15. The method of claim 10, wherein the hierarchical attention reflects information of lower-level computational nodes in a higher-level computation node based on a classification (CLS) token.

16. An apparatus for analyzing a brain-inspired neural network, comprising:
a computational graph conversion module configured to convert an input brain-inspired neural network into a computational graph;
a network representation learning module configured to perform attention computation on the computational graph based on a graph attention network, and output a result of network representation learning for the brain-inspired neural network based on the attention computation; and
a memory.

17. The apparatus of claim 16, wherein the computational graph comprises computational nodes corresponding to a neuron node, a soma node, a dendrite node, an axon node, and a synapse node.

18. The apparatus of claim 17, wherein the soma node, the dendrite node, and the axon node belong to any one neuron node.

19. The apparatus of claim 17, wherein the graph attention network performs the attention computation by combining hierarchical attention with masked self-attention.

20. The apparatus of claim 19, wherein:
the hierarchical attention is performed by applying a hierarchical structure of the neuron node, and
the masked self-attention reflects an information flow between time-dependent computational nodes based on a sequential progression starting from the neuron node and corresponding to the dendrite node, the soma node, the axon node, and the synapse node.
